(19) United States
(12) Patent Application Publication
(10) Pub. No.: US 2002/0188646 A1
(43) Pub. Date: Dec. 12, 2002

(54) Print information capture and correlation

(76) Inventors: Jody L. Terrill, Boise, ID (US); Brian E. McKinley, Boise, ID (US); James W. Lomas, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/876,354

(22) Filed: Jun. 6, 2001

(51) Int. Cl. G06F 9/00

(52) U.S. Cl. 709/101; 709/100

(57) ABSTRACT

A port monitor is adapted to obtain pre-print and post-print information for each print job handled, to correlate that information and to store it for later transfer to a management server. Upon receiving a print job, the port monitor combines a unique job identifier to the print job, and sends the combination to a printer. The port monitor captures selected pre-print information related to the print job from the peripheral server. The port monitor may poll the printer to learn of the completion of the print job. Upon completion of the print job, the port monitor obtains post-print information from the printer. The port monitor correlates pre-print information and post-print information having like unique job identifiers. The correlated information is transferred to a storage module. Upon realization of a threshold, a data transfer module sends the print information to a report manager on a management server.

### TECHNICAL FIELD

This invention relates to an apparatus and method for capturing information associated with a print job, and in particular, to an apparatus and method for selecting, collecting, correlating and transmitting pre-print and post-print information associated with a print job.

### BACKGROUND

A print job passing from a client computer to a printer, through a network including a peripheral server running a spooler application includes both print data and print information. The print data typically includes page description language (PDL) commands. Page description language describes the appearance of text, graphical shapes and images to be displayed on an output device, such as a printer.

The print information includes pre-print information and post-print information. Pre-print information includes data that is known before the printing process, such as the owner of the document to be printed and the application (such as a specific word processor) that created the document. Post-print information includes data that is known after the printing process, such as the time required to print, the quantity of toner used in the printing process, and the success or failure of the printing process.

Correlation of the pre-print and post-print information is difficult. In known print environments, an application running on the peripheral server uses API (application programming interface) calls to obtain pre-print information from the operating system. Other information is obtained during the printing process, and is typically stored by the printer in a job table. A management server includes an application that, for each print job, collects the spooler's job information from a storage location on the peripheral server, and the printer's job information from a storage location in the printer's job table.

This method results in several problems. First, an efficient method to correlate the information from the two locations is not available. Second, the application running on the management server must look in two locations, i.e. the peripheral server and the printer's job table, to obtain information on each print job. Third, communication between these three locations results in additional network traffic that is repeated for each print job, and can result in significant overhead. Fourth, information collected by an application running on the peripheral server that is not desired by the application running on the management server is routinely collected, saved and transmitted over the network, resulting in unnecessary overhead.

Accordingly, there is a need for an apparatus and method for print data capture that provides the ability to correlate pre-print and post-print information from a print job; that consolidates the location of the print job information; that reduces the system resources and network traffic associated with obtaining and storing the print job data; and that allows greater control over the selection of the information captured.

### SUMMARY

Methods and systems for obtaining and correlating information associated with print jobs are described. In one implementation, this information includes pre-print information and post-print information. Preprint information includes information known prior to the printing process, such as the owner of the job and the application that created the job. Post-print information includes information that is known after the printing process has completed, such as the time required for job completion, the quantity of toner or ink used, and the success of the print process.

A port monitor operating on a peripheral server assigns a unique job identifier to each print job it receives. The port monitor bundles the unique job identifier and print job, and sends the bundled print job to a printer.

The port monitor captures selected pre-print information related to the print job from the peripheral server. In a typical Windows® environment, this capture is performed by API calls to the Windows® print subsystem. By selecting only that information which is desired, overhead associated with unnecessary information is eliminated.

The port monitor obtains post-print information from the printer, typically using SNMP (simple network management protocol) Gets and/or Traps. In one implementation, the port monitor polls the printer to learn of the completion of the print job. Optionally, the port monitor may increase, decrease or vary the frequency of the polling with time; i.e. the number of polls made per unit of time before the job is likely to have had sufficient time to complete is reduced, and the number of polls made per unit of time after the job is likely to have been completed is increased. As a result, overall network traffic is reduced, and the port monitor obtains more timely notification of the print job completion.

Following completion of the print job, the pre-print information and post-print information associated with a unique job identifier are correlated. The correlated information is then stored within a data store associated with the print monitor. Upon realization of a threshold, a data transfer module sends the correlated print information to a report manager on a management server.

### BRIEF DESCRIPTION OF THE DRAWINGS

The same numbers are used throughout the drawings to reference like features and components.

FIG. 1 is a diagrammatic illustration of an exemplary network adapted for print information capture and correlation.

FIG. 2 is a diagrammatic view of the peripheral server, illustrating the major functional blocks.

FIG. 3 is a flow diagram showing steps in a method for capturing and correlating information associated with a print job.

### DETAILED DESCRIPTION

Overview

In accordance with the implementations described below, print information is captured from both a peripheral server and a peripheral, and correlated. Generally, a peripheral server receives a print job from a workstation or other client computer over a network. A globally unique job identifier is assigned to the print job, and the combination is sent to a printer or other peripheral. Selected pre-print information related to the print job is captured from the peripheral server. The printer is polled to determine the completion of the print job. Typically, the polling rate is increased after sufficient time for the print job to complete has past. As a result, network traffic is reduced, and more timely notification of the print job completion is obtained. Upon completion of the print job, post-print information is obtained from the printer, typically using SNMP (simple network management protocol) Gets and/or Traps. The pre-print information and post-print information associated with a unique job identifier are then correlated and transferred to a data store. Upon realization of a threshold, the correlated print information is then sent to a report manager on a management server.

Exemplary Printing Environment

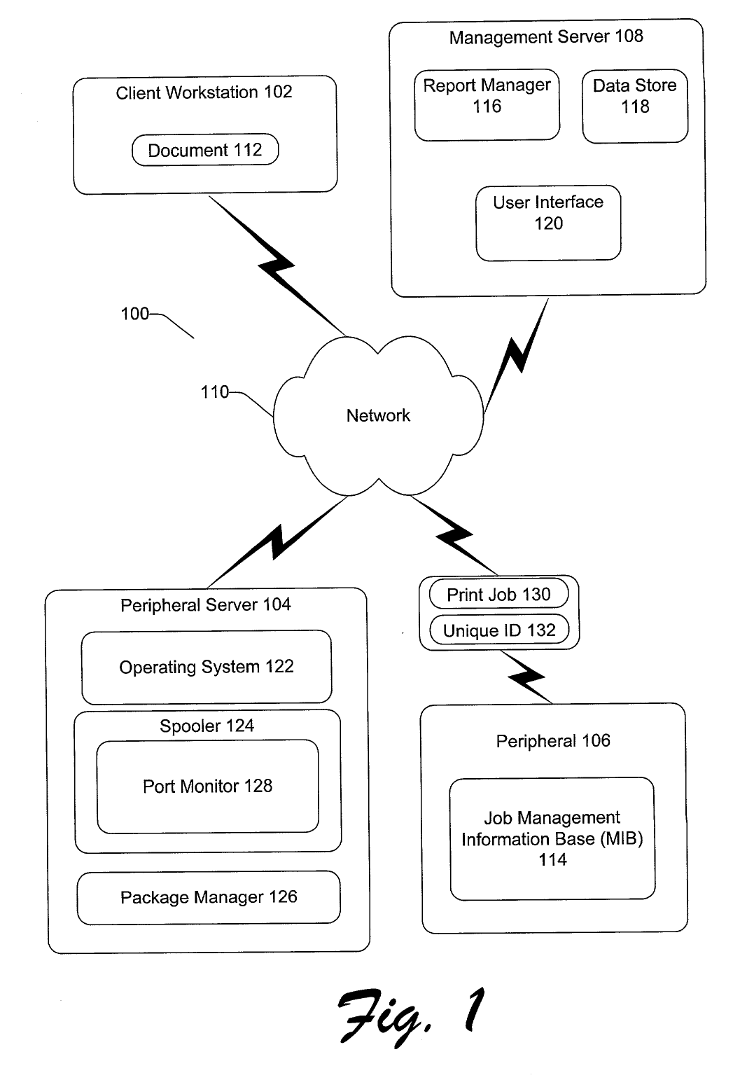

FIG. 1 shows an exemplary network architecture 100 configured to capture and correlate pre-print and post-print information. The network architecture includes a plurality of workstations 102, peripheral servers 104, peripherals 106 and management servers 108. Each device is connected to a network 110, which can be a local area network (LAN), a wide area network (WAN) or other network topology. For reasons of illustrative clarity, only a few devices are shown coupled to the network 110 of FIG. 1. However, in some applications the network could have tens or hundreds of devices. Furthermore, the network 110 may be coupled to one or more other networks, thereby providing coupling between a greater number of devices. Such can be the case, for example, when network is connected to the Internet.

The client 102 may be a workstation, personal computer or similar device, typically having an operating system, print driver, application software and a document 112 that the user of the workstation may desire to print.

The peripheral server includes an operating system 122, a spooler application 124, and a package manager 126. The spooler application 124 operates on the peripheral server in a conventional manner, receiving print jobs from clients over the network, and passing them to the port monitor.

A package manager 126, such as Hewlett-Packard's Federation Package Manager, is configured to install all of the necessary files and to start the port monitor as a service. In one implementation, a package manager is pushed by the management server and given a URL of the package to install. The package provides the information that will allow the package manager to install the port monitor 128. Once the port monitor is started in this manner, communication between the management server and port monitor is possible. An uninstall feature may be provided, and made accessible from the management server user interface 120 to allow the port monitor to be removed.

A port monitor 128 is in communication with the spooler, and is associated with one or more logical ports that are defined by the hardware of the peripheral server. The port monitor is defined by computer- or controller-readable media having computer- or controller-executable instructions. Such instructions, when executed by a CPU within the peripheral server, support the capture and correlation of pre-print and post-print print job information in a manner consistent with the disclosed methods. The instructions also support the assignment of a unique job identifier 132 to a print job 130, which facilitates the information correlation.

The management server 108 has a report manager 116 and a data store 118 that may include a database defined on persistent storage media. The management server 108 may reside on the same computer system as the peripheral server or may be supported by a distinct machine. A user interface 120 includes HTML support, and allows control over the port monitor 128 on the peripheral server 104.

A peripheral 106 may be a printer, facsimile machine or other device. In the implementation of FIG. 1, the peripheral is a printer with a job management information base (MIB) 114. The MIB stores data, provides information on the stored data, and transfers that data upon request.

Port Monitor Architecture

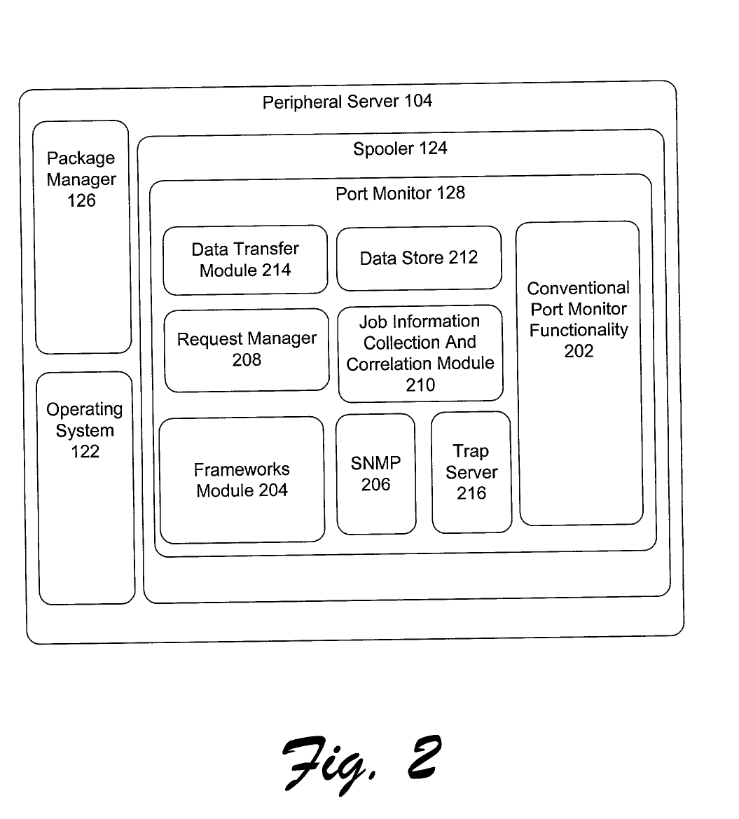

FIG. 2 shows an exemplary architecture of the peripheral server 104 and an associated port monitor 128. The port monitor utilizes conventional port monitor functionality 202 to provide software support for at least one logical port, which is provided for in the hardware of the peripheral server. Thus, the port monitor 128 is able to function in a conventional manner, whereby a document received on the peripheral server 104 by the spooler 124 is processed by the conventional port monitor functionality 202, allowing access to the logical port through which the document is passed, thereby gaining access to the network and passage to the printer or other peripheral.

The port monitor 128 further includes a frameworks module 204, such as Hewlett-Packard's Web JetAdmin Frameworks. The frameworks module allows the port monitor 128 to be developed as a plug-in module, such as a plug-in to Web JetAdmin Frameworks. The Web JetAdmin frameworks and port monitor plug-in can be pushed from the management server 108 during installation. Following installation, the port monitor plug-in can be started, configured and operated from the user interface 120 on the management server through an HTTP protocol.

A request manager 208 interfaces with an HTTP server within the frameworks module 204, or similar functional package. The requests handled by the request manager 208 arrive as the payload of an HTTP request and constitute well-formed XML (extensible mark-up language) streams. The request manager is configured to parse and validate the request from the stream and to respond appropriately.

The request manager 208 is configured to service a number of requests, which are primarily directed from the management server 108. For example, the request manager 208 may be requested to return information on the port monitor's current configuration. Configuration information may include such data as the threshold at which print information is transferred from the port monitor to the management server. The request manager may be requested to modify the port monitor's configuration based upon the data sent in the XML stream, and to return the status of the request. The request manager may be requested to get environmental information, which results in the return of information such as the enumeration of the print queues on the spooler. The request manager may be requested to get job information, which results in the return of any print job information that has been captured and which is pending transfer to the management server.

A job information collection and correlation module 210 within the port monitor is configured to assign a globally unique identifier 132 to a print job 130, to collect pre-print information from the peripheral server, to collect post-print information from the printer and to correlate the pre- and post-print information. The globally unique identifier 132, seen in FIG. 1, can be generated in any manner practical, and may optionally include elements of an ID of the port monitor or peripheral server, the workstation from which the job originated, the date, time, and a sequential number.

The job information collection and correlation module 210 obtains pre-print information about the print job from the operating system 122 of the peripheral server. Typically, data structures such as JOB_INFO_{—}2 and DEVMODE have been masked during port monitor configuration to eliminate unwanted information. API calls to the operating system using such data structures allows the desired information to be obtained.

The job information collection and correlation module 210 is configured to poll the printer or other peripheral to determine the availability of post-print job information. Optionally, the job information collection module may be configured to use an adaptive polling technique, in which the rate of the polling is increased with time. In particular, the rate of polling is slower during the period of time before the job is completed, and is increased after it is expected that the print job is completed. For example, where information contained within the job information collection module about a print job in progress is consistent with a one- to two-minute print time, a slower polling rate is appropriate during in the first minute, and a faster polling rate is appropriate between 60 and 90 seconds, and still faster polling rate is appropriate after 90 seconds. As a result, network traffic due to polling is reduced, and the elapsed time between job completion and a poll is minimized.

The job information collection and correlation module 210 is configured to use the unique job ID to walk through the job table or job MIB of the printer to find the unique ID associated with a print job, upon notification of job completion. The job information collection and correlation module 210 is configured to monitor the job via SMNP Gets, and to capture the final print information including job completion time from the job MIB, upon finding the job in the printer's MIB.

An SNMP module 206 allows job information to be collected from the printer or other peripheral using SNMP. In one implementation of the port monitor, the core set of job related SNMP objects provides sufficient functionality to obtain the required post-print job information. In an alternate implementation, network management protocol or management protocol may be substituted for SNMP. Accordingly, in such an implementation, the SNMP module would be a network management protocol module or management protocol module.

A data store 212 holds pre- and post-print job information until it is sent to the management server. The data store 212 is also configured to accept print job information from the job information collection module 210 and to provide data to the data transfer module 212 when requested. The configuration of the data store controls the storage technique used, including the format and data structures used, which results in data persistence and integrity. In one implementation, job information is retained in an XML format, since retention of this format speeds transmission to the management server.

A data transfer module 214 contained within the port monitor manages the transmission of the job information from the data store 212 to the management server 108. The transmission of the job data may be triggered from within the port monitor by the attainment of a threshold value or by a request from the management server. The functionality of the thresholds and triggers may be contained within the data transfer module 214, data store 212 or other location.

The threshold used to trigger the data transfer module may be based on: the amount of print information currently stored in the data store 212; the elapsed time since the last transfer made by the data transfer module; the amount of free storage space remaining; or elements of more than one trigger. For example, where the data store is nearing capacity, a threshold may be triggered by the size of the storage space remaining available. Similarly, a threshold time may be set to equal any desired period of time, causing operation of the data transfer module after that time has elapsed. Alternatively, the operation of the data transfer module may be triggered by the first of either of these events to occur.

The report manager 116 on the management server 108 may request the data transfer module 214 to transfer the data within the data store 212. When such a request to pull the data occurs, the data transfer module resets any thresholds being used as if the threshold had been reached.

An optional trap server module 216 may be included in the port monitor 128. The trap server module 216 functions as an aid to the job information collection and correlation module 210. The trap server module provides the mechanism for registering and listening for job related traps such as the HP Private Printer MIB Objects CURRENT-JOB-PARSING-ID and JOB-INFO-CHANGE-ID. The use of traps may reduce or eliminate the need to poll the printer or other peripheral, and allows the printer to inform the trap server and the job information collection modules of state changes in the print job. The decision to use a trap server module in part depends on whether traps are supported by the printers in question and the reliability of traps in the given print environment.

Capturing and Correlating Print Job Information

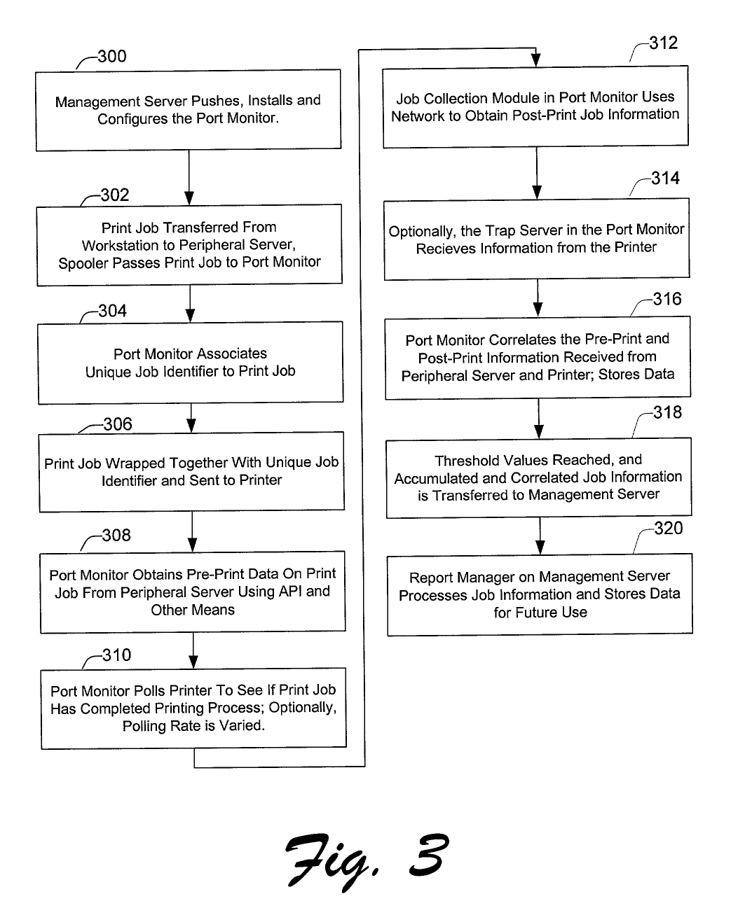

FIG. 3 illustrates a process of capturing and correlating pre- and post-print job information. The blocks illustrated in FIG. 3 may be implemented in software and/or hardware, and may be formulated by computer-readable instructions defined in a computer-readable media. The statements, when executed by a computer, controller, CPU or other device, result in the functionality of each block, as shown and described. While the below blocks are described with reference to a print job, it is understood that the job could alternatively be a facsimile transmission or operation of a similar device.

At block 300, the management server pushes, installs and configures the port monitor 128. The port monitor is configured as a plug-in for the frameworks 204, and is easily pushed from the management server. Within the framework environment, such as that created by Hewlett-Packard's Web JetAdmin Frameworks, the port monitor is remotely started and controlled through a user interface 120 with HTTP support on the management server. FIG. 1 shows the relationship between the port monitor 128 operating on the peripheral server 104 and the user interface 120 with HTML (hyper text markup language) support operating on the management server 108.

Using the interface on the management server, the port monitor is then configured as desired. The configuration process typically includes selection and/or adjustment of the values for thresholds used in controlling operation of the data transfer module 214, which are discussed below in conjunction with block 318. For example, the user interface 120 of the management server may be used to set all of the thresholds of all of the port monitors on a network to the same value. Any threshold value may later be adjusted, using the interface 120.

The interface 120 may also be used to configure the job information collection module to select only the data desired. For example, the configuration process may include masking data structures such as JOB_INFO_{—}2 and DEVMODE to result in the collection of only the print information that is desired.

At block 302, a print job is transferred from a workstation or other client 104 to the peripheral server 104, where the spooler 124 receives it. The spooler transfers the print job to the port monitor 128.

At block 304, the port monitor associates the print job with a unique identifier. The unique identifier may incorporate the date, time, ID of the port monitor and other data, as desired.

At block 306, the print job is wrapped together with the unique identifier and is sent to the printer.

At block 308, the port monitor obtains pre-print information on the print job from the peripheral server using API calls and other means. Typically, this involves communication between the port monitor and operating system 122. Pre-print information includes such data as the owner of the print job and the application that created the print job.

At block 310, the port monitor polls the printer or other peripheral to see if the job has completed the printing process. This functionality may be contained within the job information collection and correlation module 210.

At block 312, the job information collection and correlation module 210 in the port monitor obtains post-print information over the network from the job table or job management information base of the peripheral. This transfer is typically performed by a series of SNMP Gets. The job information collection module uses the SNMP module 206 to walk through the job table or MIB of the printer, until the post-print information associated with the unique ID of the job in question is found.

In an optional step at block 314, the trap server 216 receives an indication of job completion, thereby triggering the transfer of the post-print data.

At block 316, the job information collection and correlation module 210 in the port monitor correlates the pre-print and post-print information using the unique identifier. This correlation is simplified, because pre-print information having a given unique identifier is associated with post-print information associated with the same identifier. Once correlated, the data is transferred to the data store 212. Alternatively, the data may be stored in the MIB or job table of a peripheral, or may be sent to the management server for storage via an interprocess communication (IPC).

At block 318, the threshold governing the transfer of the print information is exceeded. If the threshold is time-based, this indicates that the threshold-value of time has elapsed since the threshold was last reset. Alternatively, if the threshold is storage-based, this indicates that a threshold-value of storage has been used or remains. In a still further alternative, the threshold may be based on the number or print jobs completed, or may be based on a combination of time-based, storage-based or print job number based constraints, wherein attainment of either threshold triggers the data transfer module. Attainment of any threshold causes the data transfer module 214 to transfer the data from the data store 212 to the management server.

At block 320, the report manager 116 on the management server 108 receives the data. The data is processed by the report manager, if necessary, and is transferred to a data store 118.

### CONCLUSION

By assigning a unique ID to each print job, the port monitor is able to obtain, correlate and store pre-print and post-print job information for later transfer to a management server.

Although the invention has been described in language specific to structural features and/or methodological steps, it is to be understood that the invention defined in the appended claims is not necessarily limited to the specific features or steps described. Rather, the specific features and steps are disclosed as implementations of the claimed invention.

1. A method, comprising:
associating a print job with a unique job identifier;
obtaining pre-print information about the print job;
obtaining post-print information about the print job; and
correlating the pre-print information and the post-print information having like unique job identifiers.

2. A method as recited in claim 1, wherein the pre-print information is received from an operating system.

3. A method as recited in claim 1, wherein the post-print information is obtained from a peripheral.

4. A method as recited in claim 3, wherein the peripheral is selected from among a group of peripherals comprising a printer and a facsimile machine.

5. A method as recited in claim 1, wherein the obtaining post-print information step comprises use of SNMP Gets.

6. A method as recited in claim 1, further comprising storing the unique identifier, the pre-print information and the post-print information.

7. A method as recited in claim 1, additionally comprising sending the unique identifier, the pre-print information and the post-print information to a job table on a peripheral.

8. A method as recited in claim 1, additionally comprising sending the unique identifier, the pre-print information and the post-print information to a management server.

9. A method as recited in claim 1, further comprising transferring the pre-print information and the post-print information to a management server upon realization of a threshold.

10. A method as recited in claim 9, wherein the threshold is selected from a group of thresholds comprising an elapsed time threshold, a storage level threshold and a print job quantity threshold.

11. A method as recited in claim 9, additionally comprising adjusting a value at which the threshold triggers the transfer of data.

12. A method as recited in claim 1, additionally comprising polling a peripheral to determine if the peripheral has finished with the print job.

13. A method as recited in claim 12, wherein the polling step comprises varying the rate of polling as the peripheral works on the print job.

14. A method as recited in claim 1, additionally comprising requesting the peripheral to send a trap with print information.

15. A computer readable media having computer readable instructions for performing the steps of the method as recited in claim 1.

16. A method of capturing print job information, comprising:
configuring the port monitor with a management server;
associating a print job received by a port monitor with a unique job identifier;
sending the print job to a printer;
obtaining pre-print information about the print job;
obtaining post-print information about the print job; and
correlating the pre-print information and the post-print information having like unique job identifiers.

17. A method as recited in claim 16, wherein configuring comprises configuring a plurality of port monitors to have a same threshold value.

18. A method as recited in claim 16, wherein configuring comprises generating a user interface on the management server that is supported by HTML.

19. A method as recited in claim 16, additionally comprising polling the printer to determine if the printer has finished with the print job.

20. A method as recited in claim 16, wherein the polling step comprises varying the rate of polling as the printer works on the print job.

21. A computer readable media having computer readable instructions for performing the steps of the method as recited in claim 16.

22. A method, comprising:
receiving a print job with a port monitor;
wrapping the print job with a unique job identifier to form a wrapped print job;
sending the wrapped print job to a printer;
obtaining pre-print information associated with the print job from an operating system;
polling the printer to determine if the print job is done;
obtaining post-print information from the printer; and
correlating the pre-print and post-print information to produce correlated information.

23. A method as recited in claim 22, wherein polling comprises polling at a varying rate as the printer works on the print job.

24. A method as recited in claim 22, additionally comprising triggering the transfer of correlated information to a management server upon reaching a threshold.

25. A method as recited in claim 24, wherein the threshold is selected from a group of thresholds comprising an elapsed time threshold and a storage available threshold.

26. A method as recited in claim 24, additionally comprising adjusting the threshold that triggers the transfer of data.

27. A port monitor, comprising:
a job information module to assign unique job identifiers to print jobs; and
a job collection module to collect and correlate pre-print and post-print information.

28. The port monitor of claim 27, additionally comprising a data store, in communication with job information collection module, to store the pre-print and post-print information.

29. The port monitor of claim 27, additionally comprising a data transfer module, in communication with the job information collection module, to transfer data from the job information collection module.

30. The port monitor of claim 27, additionally comprising an SNMP module, in communication with the job information collection module.

31. At least one computer-readable media having computer readable instructions thereon, which when executed by a computer, cause the computer to:
receive a print job;
wrap the print job with a unique job identifier to create a wrapped print job;
send the wrapped print job to a printer;
obtain pre-print information from an operating system;
obtain post-print information from the printer; and
correlate the pre-print information and the post-print information associated with the unique job identifier.

32. A computer-readable media as recited in claim 32, to additionally cause the computer to poll to determine if the printer has finished with the print job.

33. A computer-readable media as recited in claim 32, to additionally cause the computer to vary a rate of polling as the printer works on the print job.

34. A computer having a processor capable of reading the computer readable media of claim 32 and executing the associated instructions.
